(19) United States
(12) Patent Application Publication
(10) Pub. No.: US 2010/0225277 A1
(43) Pub. Date: Sep. 9, 2010

(54) BATTERY CHARGE AND DISCHARGE CONTROLLER

(75) Inventors: Sam Seiichiro Ochi, Saratoga, CA (US); Pierre R. Irissou, Sunnyvale, CA (US); Charles Coleman, Fort Collins, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ASIC Advantage Inc., Sunnyvale, CA (US)

(21) Appl. No.: 12/719,204

(22) Filed: Mar. 8, 2010

Related U.S. Application Data
(60) Provisional application No. 61/157,949, filed on Mar. 6, 2009.

(51) Int. Cl. H02J 7/00

(52) U.S. Cl. 320/132

(57) ABSTRACT

Methods, systems, and devices are described for described for providing control circuitry for use with battery packs. Embodiments optimize charging and discharging cycles to mitigate overcharging, over-discharging, and/or overheating individual cells in a battery pack. For example, embodiments allow for full discharging of battery packs (i.e., bringing the battery pack and its individual cells closer to their minimum voltages without going below) and full charging of battery packs (i.e., charging each cell of the battery pack closer to their maximum voltages without exceeding). Further, some embodiments include a substantially lossless, bi-directional DC-to-DC converter for facilitating ultra-fast charging of battery packs (e.g., at greater than 10C charge rates) without overheating or overcharging the individual cells of the battery packs.

### CROSS-REFERENCES

This application claims priority from co-pending U.S. Provisional Patent Application No. 61/157,949, filed Mar. 6, 2009, entitled “BATTERY CHARGE AND DISCHARGE CONTROLLER” (Attorney Docket No. 027342-002000US), which is hereby incorporated by reference, as if set forth in full in this document, for all purposes.

### FIELD

The present invention relates to controller circuits in general and, in particular, to charge and discharge controller circuits for battery packs.

### BACKGROUND

Many electronics applications use rechargeable battery packs to provide power to the application. For example, rechargeable lithium-ion batteries of various chemistries, combined into multi-cell battery packs, are often used for powering laptops, power tools, automobiles, and other applications. With proper use and application, the lithium-ion batteries can manifest relatively high energy densities. However, the lithium-ion batteries may also be sensitive to overcharging and over-discharging.

FIG. 1 shows an illustrative discharge characteristic curve 105 for an exemplary 3.3-volt, 2-Amp-hour, lithium-ion cell at 25° C., discharged at a constant one Amp discharging current. As shown, the fully charged battery operates substantially at its Vmax 110, around 3.8V. As the battery discharges, the operating voltage quickly drops to around 3.3V, where it remains constant for most of its discharge cycle. Near the end of its discharge cycle (at around 2-Amp-hours, its rated capacity), the operating voltage of the battery again drops sharply, this time substantially to the battery's Vmin 115, around 2V. The charging cycle may operate along a similar curve to the discharge characteristic curve 105. For example, the charging cycle may end with a sharp rise toward the battery's Vmax 110.

Improper charging or discharging of the cells may adversely impact the functionality (e.g., the capacity, life, etc.) of individual cells and the battery packs in which they are used. As such, it may be desirable to address a number of factors for optimal charging and discharging of lithium-ion battery packs. One consideration is the avoidance of overcharging individual cells in the battery pack above their maximum rated voltage, Vmax (e.g., typically 3.3V to 4.2V depending on the cell chemistry and construction used). For example, overcharging may occur when some cells in a battery pack reach their Vmax while others are still being charged, or because it may be difficult to avoid overshooting the Vmax as a result of the rapid rise toward Vmax at the end of the charging cycle. Another consideration is the avoidance of over-discharging the individual cells in the battery pack below their minimum rated voltage, Vmin (e.g., typically 1.9V to 2.3V depending on the cell chemistry and construction used). For example, over-discharging may occur when some cells in a battery pack reach their Vmin while others are still being discharged, or because it may be difficult to avoid overshooting the Vmin as a result of the rapid drop toward Vmin at the end of the discharging cycle. Still another consideration is the avoidance of overheating the individual cells in the battery pack beyond their maximum rated temperature, Tₘₐₓ (e.g., typically 80° C. to 125° C. depending on the cell chemistry and construction used). For example, overheating may occur when cells are placed in environments where temperatures exceed Tmax, or where battery pack controllers attempt to dissipate heat in excess of Tmax.

As such, it may be desirable to provide control circuitry for use with battery packs that can optimize charging and discharging cycles to mitigate overcharging, over-discharging, and/or overheating individual cells in the battery pack.

### BRIEF SUMMARY

Among other things, systems, devices, and methods are described for providing control circuitry for use with battery packs. Embodiments optimize charging and discharging cycles to mitigate overcharging, over-discharging, and/or overheating individual cells in a battery pack. For example, embodiments allow for full discharging of battery packs (i.e., bringing the battery pack and its individual cells closer to Vmin without going below it) and full charging of battery packs (i.e., charging each cell of the battery pack closer to its Vmax without exceeding it). Further, some embodiments include a substantially lossless (e.g., over 85-percent-efficient) DC-to-DC converter for facilitating ultra-fast charging of battery packs (e.g., at greater than 10C charge rates) without overheating or overcharging the individual cells of the battery packs.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a second label (e.g., a lower-case letter) that distinguishes among the similar components. If only the first reference label is used in the specification, the description is applicable to any one of the similar components having the same first reference label irrespective of the second reference label.

FIG. 1 shows an illustrative discharge characteristic curve for an exemplary 3.3-volt, 2-Amp-hour, lithium-ion cell at 25° C., discharged at a constant one Amp discharging current.

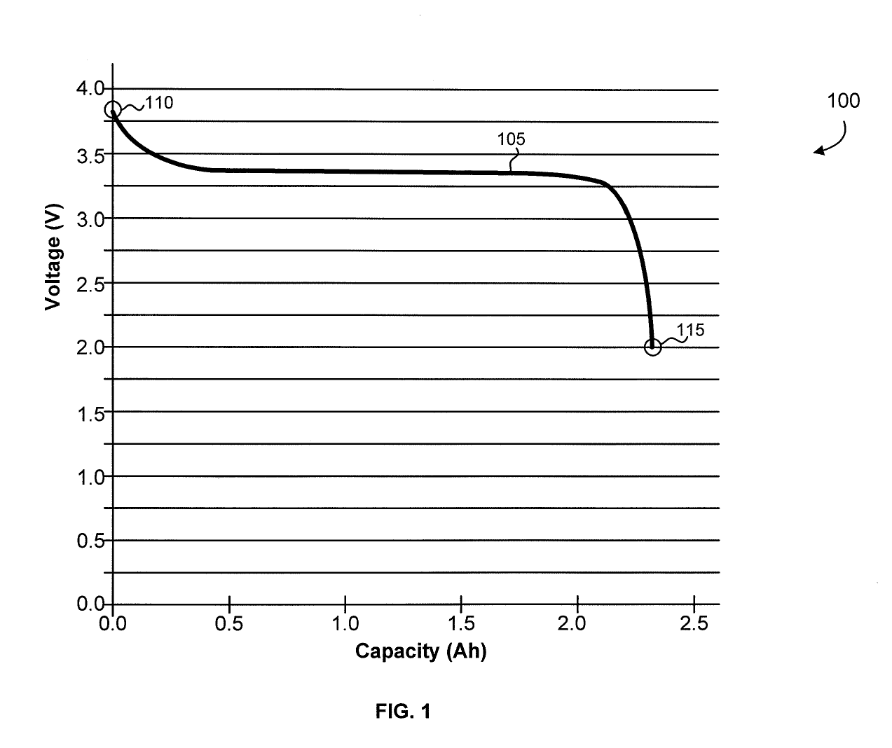

FIG. 2 shows a simplified block diagram of an illustrative rechargeable battery pack, according to various embodiments.

FIG. 3 shows a simplified block diagram of a cell controller module, like the one described with reference to FIG. 2, according to various embodiments.

FIG. 4 shows an illustrative schematic diagram of a cell controller module, like the ones described with reference to FIGS. 2 and 3, according to various embodiments.

FIG. 5 shows a flow diagram of an embodiment of a method for controlled charging of a cell of a battery pack, according to embodiments.

FIG. 6 shows a flow diagram of an embodiment of a method for controlled discharging of a cell of a battery pack, according to embodiments.

### DETAILED DESCRIPTION

Embodiments are described herein for providing control circuitry for use with battery packs, for example, to optimize charging and discharging cycles (e.g., to mitigate overcharging, over-discharging, and/or overheating individual cells in a battery pack). Notably, many typical battery packs avoid overcharging and/or over-discharging by prematurely stopping those respective cycles. For example, in some automotive applications, batteries may be charged only to around eighty-percent and discharged only to around twenty-percent, leaving only about sixty-percent of the battery's capacity for use in operating the automobile.

Some embodiments may allow for full and reliable discharging of battery packs (i.e., bringing the battery pack and its individual cells closer to Vmin without going below it) and full and reliable charging of battery packs (i.e., charging each cell of the battery pack closer to its Vmax without exceeding it). Further, some embodiments include a substantially lossless (e.g., over 85-percent-efficient) DC-to-DC converter for facilitating ultra-fast charging of battery packs (e.g., at greater than 10C charge rates) without overheating or overcharging the individual cells of the battery packs.

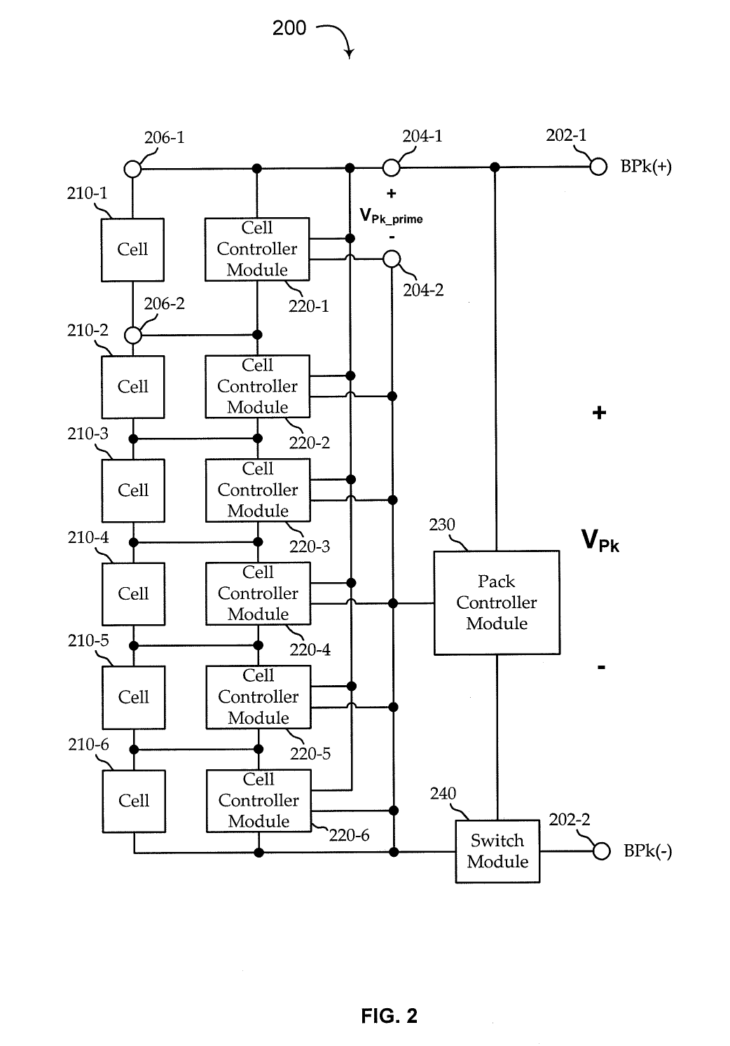

Turning first to FIG. 2, a simplified block diagram of an illustrative rechargeable battery pack 200 is shown, according to various embodiments of the invention. The battery pack 200 includes a number of cells 210, each cell being controlled by a respective cell controller module 220. The battery pack 200 is further controlled by a pack controller module 230 and a switch module 240. In some embodiments, the switch module 240 effectively turns off the battery pack (e.g., prevents it from continuing to charge or discharge) when certain charging, discharging, and/or other conditions occur.

The cells 210 are described as lithium-ion battery cells, but it will be appreciated that any type of power storage and/or conversion cell is possible according to embodiments of the invention. For example, the cells 210 may include rechargeable cells (e.g., nickel-cadmium battery cells, capacitors, super-capacitors, etc.) or non-rechargeable cells (e.g., non-rechargeable battery cells, solar cells, etc.). Further, as is typical of many battery packs 200, it is assumed that the cells 210 are effectively wired in series. In some embodiments, the battery pack 200 may, in fact, be a portion of a larger battery. For example, a very large battery may include hundreds of cells 210, wired in groups acting as battery packs 200.

During a charge cycle, a charge voltage is provided across the battery pack 200 (e.g., the battery pack 200 is placed into a charger that is plugged into a line voltage source, like a wall outlet, connected with an alternator in an automobile, etc.), producing a differential between the positive pack terminal 202-1 and the negative pack terminal 202-2. A charging current also begins to flow into the positive pack terminal 202-1 and out of the negative pack terminal 202-2. While the voltage across an individual cell 210 (e.g., the voltage between first cell positive terminal 206-1 and first cell negative terminal 206-2) remains substantially below its operational maximum voltage (Vmax), the charging current may flow through the cell 210, thereby causing the cell 210 to charge. As such, if all the cells are discharged (e.g., even minimally), substantially all the charging current will flow through all the cells 210 (e.g., in series), causing all the cells 210 to charge.

To avoid overcharging the cells 210, it may be desirable to detect when an individual cell 210 reaches or approaches its Vmax, and to stop charging that cell 210. For example, a threshold level may be set near, but below, Vmax for the cell 210, and the battery pack 200 may be configured to stop charging that cell 210 when the cell 210 voltage crosses that threshold level.

In some typical lithium-ion battery packs, control circuitry mitigates overcharging by providing a switchable load to act as a shunt current path (e.g., a resistor in series with a transistor). When an individual cell 210 reaches or approaches its Vmax, the shunt current path turns on, causing some of the charging current to be directed through the load, instead of through the respective cell 210. While this technique may effectively remove (e.g., at least partially) the cell 210 from the charging cycle, it may create sub-optimal or undesirable effects.

One effect may result from compromises involved with sizing the shunt load. On one hand, it may be desirable for the load to be large enough to shunt sufficient current away from the cell 210 to slow continued charging of the cell 210 in order to mitigate overcharging of the cell 210. For example, even if the load is large enough to shunt ten to twenty percent of the charging current away from the cell 210, the cell 210 may continue to sink eighty to ninety percent of the charging current until the other cells reach their Vmax (e.g., and the battery pack 200 charging cycle turns off). On the other hand, it may be desirable for the load to be small enough to avoid dissipating too much power. For example, if the load is too large, it may generate too much heat and cause the cells to be heated above their Tmax.

This effect may become magnified toward the end of the charging cycle, as more shunt current paths are turned on and more shunt loads are dissipating power. For example, suppose the battery pack 200 includes six cells 210, each being a 3.3-volt lithium-ion battery cell (the battery pack 200 voltage (VPk) is 19.8V), and the battery pack 200 is charged using a 2-Amp charging current. During charging, the third cell 210-3 reaches Vmax first, with all the other cells 210 still being charged. A current shunt path associated with the third cell 210-3 turns on and begins shunting ten percent of the charging current (i.e., 200 mA). The third cell 210-3 continues to be charged with ninety percent of the charging current (1.8 Amps), while the other batteries continue to be charged at the full charging current of 2 Amps.

At least two issues may arise. First, if the cells 210 in the battery pack 200 are not very closely matched, the third cell 210-3 may continue to charge beyond its Vmax, albeit more slowly, for an undesirable amount of time. Second, at some later point in the charging cycle, five of the six cells 210 may have reached their charging threshold (e.g., at or near Vmax). Their respective five shunt current paths may have turned on, causing five shunt loads to each see ten percent of the shunt current. The shunt loads may now be dissipating a total self-heating power of up to 3.3 Watts (i.e., 5 loads times 10% of the charging current through each load times a 2-Amp total charging current times a 3.3-volt cell voltage, or 5×0.1×2A×3.3V=3.3W). This may generate an undesirable amount of heat and may cause damage to the cells 210.

Another related effect, which may cause undesirable results, may arise from a general desirability in many applications to use shorter charging cycles. For example, the battery pack 200 may be charged with a higher charging current so as to shorten the charging cycle. For the sake of illustration, suppose that the battery pack 200 includes six cells 210, each being a 3.3-volt lithium-ion battery cell. The battery pack 200 is charged in this example using an 8-Amp charging current (e.g., as opposed to the 2-Amp charging current used in the previous example). Again, during charging, the third cell 210-3 reaches Vmax first, causing its shunt current path to turn on.

Because the operating voltage of the cell 210-3 (3.3V) is the same, the shunt current path will again divert only 200 mA of the current, assuming the shunt load size has not changed. However, instead of being ten percent of the charging current (i.e., as it was when the charging current was only 2A), the 200 mA is only 2.5% of the total 8-Amp charging current. As such, the third cell 210-3 may continue to charge substantially quickly even beyond its Vmax. It is worth noting that if the shunt load is increased to compensate, significantly more power may be dissipated as a result.

It will now be appreciated that simply shunting a portion of the charging current away from the cells 210 may be undesirable for a number of reasons. Further, the reasons may be exacerbated when higher charging currents are used and/or when cells 210 in the battery pack 200 are not well matched. As such, some typical battery packs 200 may require low charging currents and/or careful matching of cells 210 to mitigate overcharging issues.

Further, many typical battery packs 200 operate sub-optimally in their discharging cycles. For example, each cell 210 may be monitored to determine whether it has reached Vmin (or some threshold minimum voltage near Vmin). When the condition has been reached, a switch (e.g., the switch module 240) placed in series with the battery pack 200 turns off the battery pack 200. This may prevent any of the cells 210 from discharging below Vmin. However, since the discharging cycle ends when any single cell 210 reaches its Vmin, the battery pack 200 may effectively only manifest the capacity of its weakest cell 210. Thus, as discussed with regard to the charging cycle, it may be necessary to carefully match the cells 210 in many battery packs 200 to optimize their discharging cycles.

It will now be appreciated that some typical battery packs 200 may desire, or even require, low charging currents and/or careful matching of cells 210 for proper operation over time. These characteristics may create undesirable effects for consumers. For example, low charging currents may result in long charging cycles, such that consumers may have to wait a long time for a battery to recharge. Further, reliance on careful matching of cells 210 may increase costs associated with manufacturing battery packs 200 and may make the battery packs 200 prone to failure due to failure of a single cell 210.

In the battery pack 200 shown in FIG. 2, each cell controller module 220 operates to optimize charging and discharging cycles of the battery pack 200, without overheating the cells 210. During the charging cycle, each cell controller module 220 monitors the voltage across its respective cell 210. When the cell 210 reaches its Vmax (or some threshold voltage substantially close to Vmax), the cell controller module 220 turns on (e.g., activates a bi-directional, switched-mode, DC-to-DC converter, as described below).

The cell controller module 220 redirects the charging current from the cell 210 to a converter, which generates (e.g., in a lossless way, for example, with greater than 90% efficiency) a current in the VPk_prime terminals 204 having the same polarity of the charging current. In some embodiments, the current generated by the cell controller module 220 is designed to be no greater than 1/n^{th} of the charging current, where n is the number of cells 210 in the battery pack 200. For example, where the charging current is two Amps, and there are six cells 210 in the battery pack, the cell controller module 220 may generate no greater than approximately 333 mA of current.

The current generated by the cell controller module 220 may tend to increase the charging current flowing through the remaining cells 210. As such, the cell controller module 220 may effectively redistribute the excess charging current to the other cells 210 as they continue to charge. Just prior to the end of the charging cycle, all the cell controller modules 220 may be supplying around 1/n of the charging current to the VPk_prime terminals. This may effectively cause the charging current to be fully compensated so that the voltage at the VPk_prime terminals will start to rise with the application of any further external charging current. The switch module 240 may be designed to turn off the battery pack 200 (e.g., the pack controller module 230 may be designed to switch off a transistor at the negative pack terminal 202-2) to prevent overcharging of the battery pack.

It will be appreciated that the battery pack, when fully charged, may therefore have as its terminal voltage substantially at the full n-times-Vmax battery pack 200 operating voltage. Other features of the cell controller modules 220 will also be appreciated. One feature is that, because there may be little to no shunt load (i.e., the cell controller module 220 may be substantially lossless), substantially all the cell 210 current can be shunted through the cell controller module 220 without overheating the battery pack 200 or individual cells 210. Another feature is that, because substantially all the cell 210 current is shunted away from the cell 210 when it reaches its Vmax, overcharging of the cell 210 may be optimally avoided. Yet another feature is that, because the cells 210 do not continue to charge after reaching Vmax, it may not be critical to closely match the cells 210 in the battery pack 200. Still another feature is that, because operation of the cell controller module 220 is substantially independent of the charging current, the cell controller module 220 provides the same optimization (or potentially even greater optimization) when using faster charging modes.

As in the charging cycle, each cell controller module 220 measures the voltage across its respective cell 210 during the discharge cycle of the battery pack 200. When a cell 210 reaches its operational minimum voltage (Vmin), the respective cell controller module 220 turns on. However, during the discharging cycle, the cell controller module 220 operates in reverse compared to its operation during the charging cycle. Specifically, the cell controller module 220 converts the remaining VPk_prime voltage into a current, which is applied to its respective cell 210. The applied current tends to charge the cell 210.

Shortly after current is applied via the cell controller module 220 to its respective cell 210, the voltage across the cell 210 may return to a level just above its Vmin. At this point, cell controller module 220 may turn off. As such, the fully discharged cell 210 will continue to hover substantially at its Vmin, without substantially dropping below its Vmin, while the other cells 210 continue to discharge and approach their Vmin. When all the cells 210 reach Vmin, the discharge cycle will end. For example, the switch module 240 may be designed to turn off the battery pack 200 (e.g., the pack controller module 230 may be designed to switch off a transistor at the negative pack terminal 202-2) to prevent over-discharging of the battery pack 200. Again, it will be appreciated that, using the cell controller modules 220 may optimally discharge the battery pack 200 substantially to its full Vmin (e.g., n-times-Vmin). Further, it may be unnecessary to precisely match the cells 210 in the battery pack 200 to achieve this optimal discharging cycle.

It will be appreciated that configuring the battery pack 200 using cell controller modules 220 may provide a number of additional features and potential applications. One application is that, because precise cell 210 matching may be unnecessary, different types of cells 210 may be used having different capabilities. For example, battery packs 200 may have lithium-ion battery cells, nickel-cadmium battery cells, solar cells, low-voltage super capacitors, etc. This may allow for different hybrid types of battery packs, different pack manufacturing methods, etc.

Yet another potential application is the ability to implement cell 210 tapping. For example, say a two-speed drill is desired. The battery pack 200 may be tapped at half voltage to provide slow speed drilling functionality. Using the cell controller modules 220 in the battery pack 200 may allow half the cells 210 in the battery pack 200 to be tapped without damaging the battery pack 200. For example, as the tapped cells 210 are discharged, their respective cell controller modules 220 will turn on, drawing current from the other cells 210. This may cause the tapped cells 210 to begin recharging and balancing the battery pack 200 prior to being connected with a charger. Notably, multiple taps may be used to provide multiple voltage levels from the same battery pack 200. This may increase the efficiency of devices connected with the battery pack 200. Other potential applications, like testing and maintenance applications, are described more fully below.

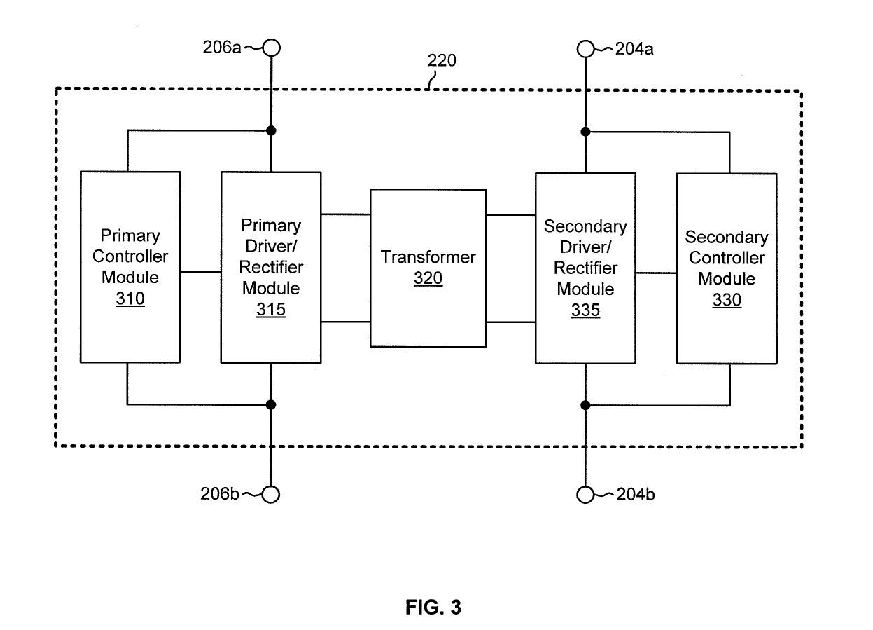

Embodiments of the battery pack 200 described above use cell controller modules 220 to optimize the charging and discharging cycles of the battery pack 200. FIG. 3 shows a simplified block diagram of a cell controller module 220, like the one described with reference to FIG. 2, according to various embodiments. The cell controller module 220 includes a primary controller module 310 and a secondary controller module 330, in communication via a transformer 320.

In some embodiments, components of the cell controller module 220 are configured to be substantially bi-directional, such that the same cell controller module 220 can facilitate charging and discharging functions. For example, the primary driver/rectifier module 315 and the secondary driver/rectifier module 335 may be designed to be used as a driver in one direction and as a rectifier in the other direction. Further, some embodiments of the cell controller module 220 are configured to provide substantially lossless conversion functionality (e.g., greater than 90% conversion efficiency).

Notably, even where the primary driver/rectifier module 315 and/or the secondary driver/rectifier module 335 are bi-directional, they may not be implemented in the same way. For example, either or both of the primary driver/rectifier module 315 and the secondary driver/rectifier module 335 may be implemented to include a half-bridge topology, a full bridge topology, a half-wave rectifier, one or more synchronous switches, and/or any other type of driver and rectifier.

In certain embodiments, the driver and rectifier circuits may be separate, while, in other embodiments, the driver and rectifier circuits may be integrated (e.g., they may share some or all of the same components). Further, in certain embodiments, the primary controller module 310 and/or secondary controller module 330 implementations may be synchronous or asynchronous, active or passive, etc. Even further, embodiments of the primary driver/rectifier module 315 and/or the secondary driver/rectifier module 335 may include additional components for wave forming, filtering, etc. (e.g., DC blocking capacitors, inductors, etc.).

Using the various types of implementations described above (e.g., or other implementations), embodiments of the cell controller module 220 provide DC-to-DC conversion functionality. A first DC voltage may be received across primary terminals 206. The first DC voltage may be converted into a first AC signal (an AC voltage) by using the primary controller module 310 to control a primary driver/rectifier module 315. The primary driver/rectifier module 315 may pass the first AC signal to the transformer 320, where it may be transformed to a second AC signal.

In some embodiments, the transformer 320 is a step down transformer, with the turns ratio being a function of the number of cells in the battery pack in which the cell controller module 220 is used. For example, if the cell controller module 220 is included in a battery pack having six cells, the transformer 320 may have a 6-to-1 turns ratio. As such, the current induced on the secondary side of the transformer 320 may be substantially one-sixth the current generated on the primary side of the transformer 320. In some embodiments, an inductor is included in series with one or more sides of the transformer 320. For example, series inductance may allow full control (e.g., full bridge control) of certain implementations of the primary driver/rectifier module 315 and/or the secondary driver/rectifier module 335 in a resonant, or soft switching, mode to improve efficiency and increase the basic switching frequency. These effects may be seen, for example, where the series inductance is on the driven (e.g., primary) side of the transformer 320, or similar effects may be realized from leakage inductance from the transformer 320.

At the secondary side of the transformer 320, the second AC signal is seen. The second AC signal may then be used by a secondary driver/rectifier module 335, being controlled by the secondary controller module 330, to generate a second DC voltage at the secondary terminals 204. As shown in FIG. 2, the primary terminals 206 may be tied to the voltage across the respective cells, and the secondary terminals 204 may be tied to the VPk_prime voltage.

It is worth noting that, where the cell controller module 220 is bi-directional, similar functionality may work in reverse. As such, the terms “primary” and “secondary” are intended only to clarify the description and should not be construed as limiting the scope of any embodiments. For example, a first DC voltage may be received across the secondary terminals 204 (e.g., as part of the discharge cycle, as discussed more below). The first DC voltage may be converted into a first AC signal by using the secondary controller module 330 to control the secondary driver/rectifier module 335. The secondary driver/rectifier module 335 may pass the first AC signal to the transformer 320, where it may be transformed to a second AC signal on the primary side of the cell controller module 220. The second AC signal may then be used by the primary driver/rectifier module 315, being controlled by the primary controller module 310, to generate a second DC voltage at the primary terminals 206.

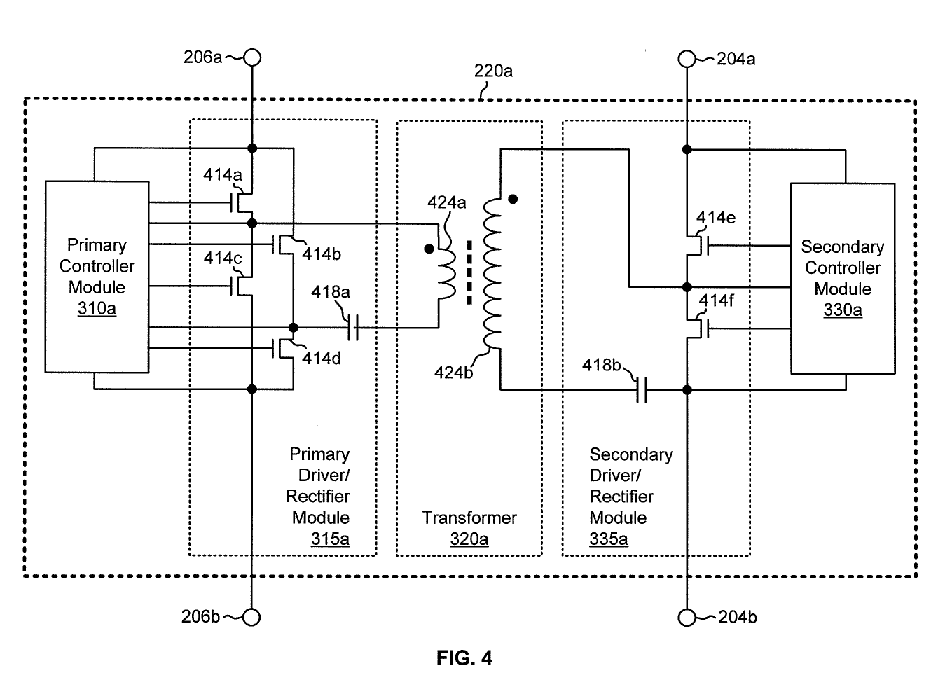

It will be appreciated from the above description that many implementations of cell controller modules 220 are possible within the scope of various embodiments. FIG. 4 shows a simplified schematic diagram of an illustrative cell controller module 220a, like the one described with reference to FIGS. 2 and 3, according to various embodiments. As illustrated, the cell controller module 220a operates substantially as a bi-directional, switched-mode, DC-to-DC converter. In some embodiments, the cell controller module 220a provides substantially lossless conversion functionality.

As in FIG. 3, the cell controller module 220a of FIG. 4 includes a primary controller module 310a and a primary driver/rectifier module 315a in communication with a secondary controller module 330a and a secondary driver/rectifier module 335a over a transformer 320a. In the illustrated embodiment, the primary driver/rectifier module 315a is configured substantially in a full bridge topology with four transistors 414 (i.e., 414a, 414b, 414c, and 414d). The primary driver/rectifier module 315a is tied to primary terminals 206, and its transformers 414 are switched in accordance to control signals generated by the primary controller module 310a. The secondary driver/rectifier module 335a is illustrated as configured substantially in a half bridge (e.g., or voltage doubler) topology with two transistors 414 (i.e., 414e and 414f). The secondary driver/rectifier module 335a is tied to secondary terminals 204, and its transformers 414 are switched in accordance to control signals generated by the secondary controller module 330a.

During the charging cycle, the four transistors 414 of the primary driver/rectifier module 315a are driven by the primary controller module 310a using switched mode techniques to convert the current flowing into the primary terminals 206 (e.g., or the voltage across the primary terminals 206) into a switched current to drive the primary side 424a of the transformer 320a. For example, the primary driver/rectifier module 315a is configured to act substantially as a full-bridge driver. In some embodiments, a DC blocking capacitor 418a is connected in series with the primary side 424a of the transformer 320a. In other embodiments, the primary controller module 310a is configured to drive the transformer 320a with precise 50% duty cycle transitions. At a 50% duty cycle, there may be no net DC current flow through the transformer 320a, such that there may be no need for including capacitor 418a.

The switched current on the primary side 424a of the transformer 320a may induce a current on the secondary side 424b of the transformer 320a. On the secondary side 424b of the transformer 320a, embodiments of the secondary controller module 330a drive the transformers 414 of the secondary driver/rectifier module 335a (e.g., a pair of synchronous rectifiers) in a voltage doubler configuration. In some embodiments, a second capacitor 418b is connected in series with the secondary side 424b of the transformer 320a.

The configuration of the transformers 414 of the secondary driver/rectifier module 335a may effectively deliver the induced current as a DC current to (e.g., or a DC voltage across) the secondary terminals 204. Notably, the current delivered to the secondary terminals 204 may have the same polarity as the charging current of the battery pack in which the cell controller module 220a is being used (e.g., as discussed with reference to FIG. 2 above). In this way, charging current diverted from a cell of a battery pack may be diverted through the cell controller module 220a, where it may be converted into a supplemental current to be recycled and redistributed to the other cells in the battery pack with substantially little self-heating power dissipation.

During the discharging cycle, the Vmin of the cell connected to the cell controller module 220a may be substantially reached (e.g., as discussed above). The secondary controller module 330a may control the transistors 414 of the secondary driver/rectifier module 335a substantially as a half bridge switching converter. The configuration of the transistors 414 of the secondary driver/rectifier module 335a may convert the current in the secondary terminals 204 into an output switching current at the secondary side 424b of the transformer 320a. In some embodiments, in this direction, the transformer 320a may step the current up to a higher induced current on the primary side 424a of the transformer 320a.

At the primary side 424a of the transformer 320a, the transistors 414 of the primary driver/rectifier module 315a may be switched by the primary controller module 310a to act substantially as synchronous rectifiers (e.g., possibly with capacitor 418a in series, as discussed above). The synchronous rectification may convert the stepped up, switched current from the secondary side 424b of the transformer 320a to a current for use in recharging the connected cell via the primary terminals 206.

In this way, some current from remaining cells that are not yet fully discharged may be diverted through the cell controller module 220a, where it may be converted into a charging current for the fully discharged cell. When the cell voltage returns to a level exceeding Vmin, the cell controller module 220a may turn off, allowing the cell to once again begin discharging. As such, the voltage across the fully discharged cell may effectively hover (e.g., oscillate) closely around Vmin until all the cells are fully discharged. As with the charging cycle operation, proper control techniques and the use of series inductance (e.g., the transformer 320a leakage inductance or a separate series inductor) can allow soft switching or resonant switching techniques to improve efficiency and increase switching frequency.

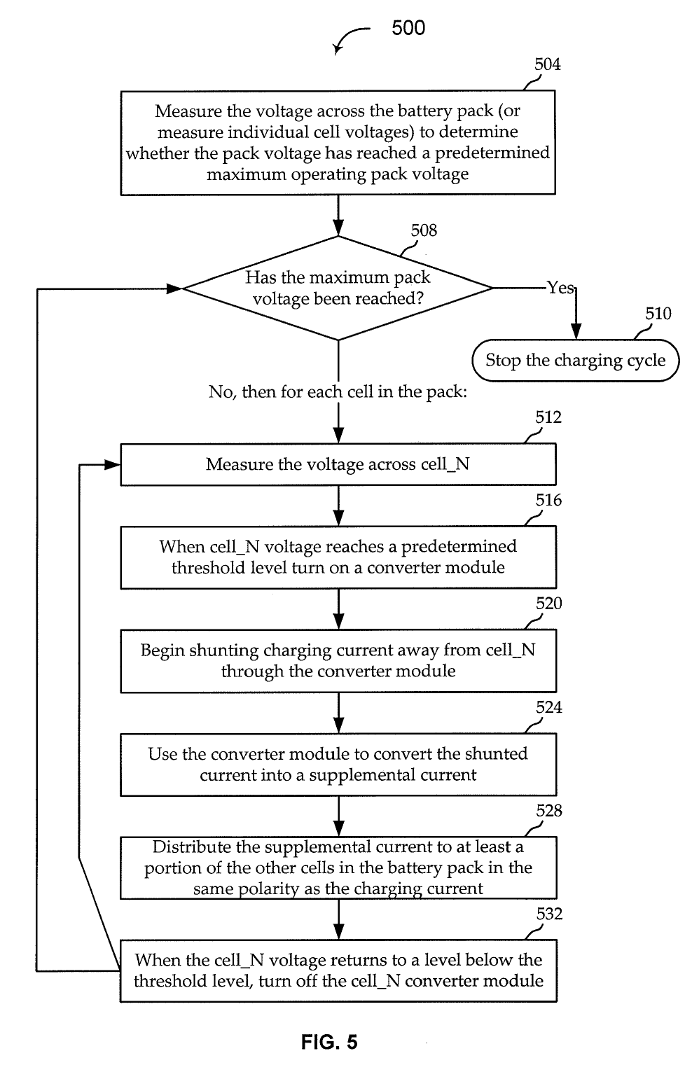

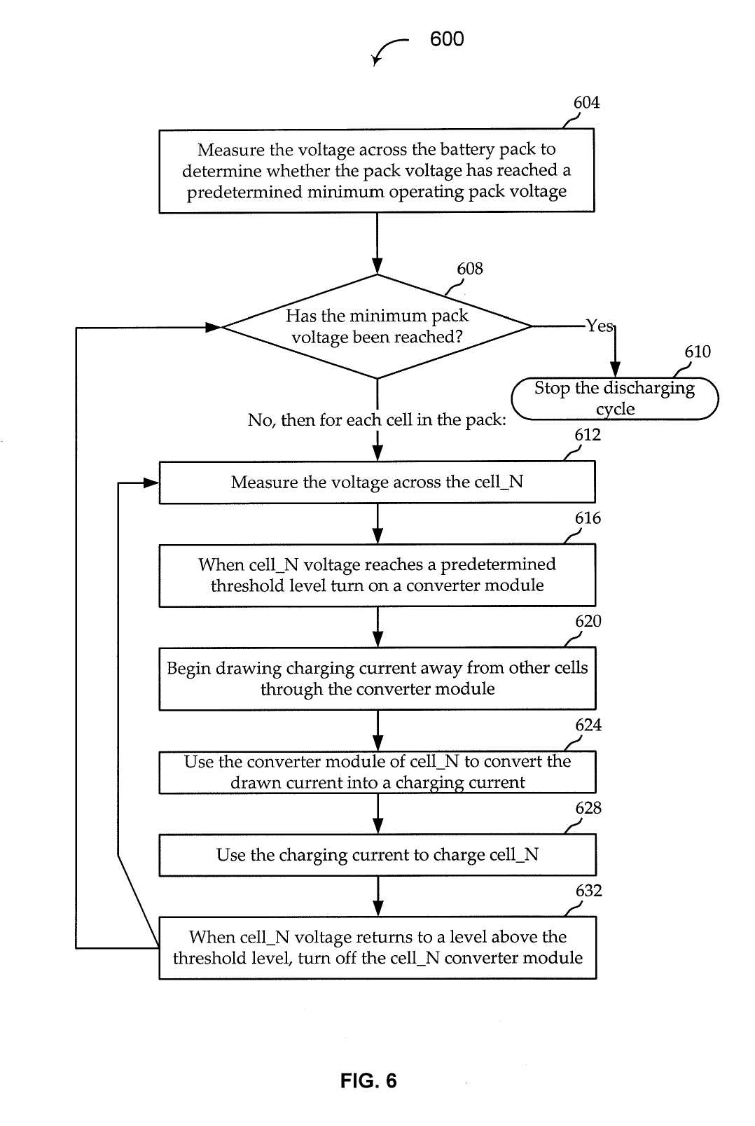

It will be appreciated that the functionality of the circuits shown in FIGS. 2-4 may be implemented in different ways without departing from the scope of the invention. For the sake of added clarity, the methods of FIGS. 5 and 6 are described in the context of the battery pack of FIG. 2 and the cell controller module of FIG. 3. However, different systems may be used to implement functionality described with respect to the methods of FIGS. 5 and 6, and the descriptions should not be construed as limiting the scope of any embodiments.

FIG. 5 shows a flow diagram of an embodiment of a method 500 for controlled charging of a cell 210 of a battery pack 200, according to various embodiments. The method 500 begins at block 504 by measuring the voltage across the battery pack 200 to determine whether the pack voltage (e.g., the voltage across terminals 202) has reached a predetermined maximum operating pack voltage (e.g., the sum of the Vmax values for the cells of the battery pack). In some embodiments, rather than measuring the pack voltage directly at block 504, voltages of individual cells may be measured (e.g., via terminals 206).

At decision block 508, a determination is made as to whether the maximum pack voltage has been reached. For example, the maximum pack voltage may be determined as an operational voltage level for the pack, as a sum of operational voltages for individual cells, as a threshold level below one or more operational voltages, etc. In some embodiments, the determination at block 508 is made by the pack controller module 230. Certain embodiments of the pack controller module 230 may be configured to perform additional detection and/or analysis functions. For example, the maximum pack voltage may not be a static value, and may instead depend on other factors (e.g., the value may be variable). For example, if the maximum pack voltage is reached too quickly, if a fault is detected, if the input signal is undesirable according to a certain specification, etc., the maximum pack voltage may be determined at block 508 to have been reached.

When the determination is made at block 508 that the maximum pack voltage has been reached, the charging cycle may be stopped at block 510. For example, a switch (e.g., a transistor, relay, etc.) may be opened to block further charging of the battery pack 200. When the determination is made at block 508 that the maximum pack voltage has not yet been reached, the method 500 may continue, according to blocks 512 through 528, for each of the number of cells in the battery pack 200. For each remaining block of the method, the cell 210 currently being affected is referred to as “cell_N 210n.” As shown in FIG. 2, each cell 210 is controlled by a respective cell controller module 220.

At block 512 the method 500 measures the voltage across cell_N 210n (e.g., via terminals 206). It is worth noting that measuring the voltage across cell_N 210n may, in fact, be implemented by measuring current flow through cell_N 210n. When the cell_N 210n voltage reaches a predetermined threshold level (e.g., at or near the cell's Vmax), at block 516, a converter module turns on. In some embodiments, the primary controller module 310 in the cell controller module 220 monitors the voltage across cell_N 210n according to block 512, and begins driving the primary driver/rectifier module 315 when the threshold level is reached according to block 516.

It is worth noting that, as with the threshold determination of block 508, the threshold determination involved in block 516 may include a variable threshold and/or other information, according to various embodiments. In some embodiments, as the voltage across cell_N 210n is measured in block 512, other information may be monitored as well. In one embodiment, the rate of change (e.g., the slope) of cell_N 210n voltage may be monitored to detect whether the change is too fast or too slow. For example, if the cell_N 210n voltage is increasing too quickly during the charging cycle, that may indicate that cell_N 210n is beginning to fail. Further, in some embodiments, the monitoring may be performed in comparison with other monitoring. For example, the pack controller module 230 may monitor the rate of cell 210 voltage change for all the cells 210 to determine whether any cell 210 is performing substantially differently from any other cell 210. In certain embodiments, other types of factors may be relevant, and may be monitored accordingly. For example, it may be desirable to detect and/or respond to cell 210, battery pack 200, or ambient temperature; signal noise; ambient light levels; other control signals, etc.

When the converter module (e.g., the cell controller module 220) turns on, it may begin shunting (e.g., diverting) charging current away from cell_N 210n at block 520. The converter module then converts the shunted current into a supplemental current at block 524. For example, as described above, a current may be transformed across a transformer 320 in the cell controller module 220, and converted (e.g., via the secondary driver/rectifier module 335 controlled by the secondary controller module 330) to the supplemental current, having the same polarity as the charging current supplied by the battery pack 200.

At block 528, the supplemental current is distributed to at least a portion of the other cells in the battery pack 200 in the same polarity as the charging current. It will be appreciated that, as the charging current is shunted away from cell_N 210n, cell_N 210n may begin to discharge. If the cell_N 210n voltage returns to a level below the threshold level (e.g., or to another threshold level), the converter may turn off at block 532. For example, the cell controller module 220 for cell_N 210n may stop driving the primary driver/rectifier module 315, which may stop shunting charging current away from cell_N 210n, thereby allowing cell_N 210n to begin charging once again.

The method 500 continues to cycle back to block 512 and back to block 504. In this way, the voltage across each cell will reach its Vmax and hover around its Vmax until all the cells reach their respective Vmax. Notably, embodiments of blocks 512 through 528 are typically performed by one or more cell controller modules 220, operating substantially asynchronously. Further, in some embodiments, the pack controller module 230 may operate substantially asynchronously with the cell controller modules 220. As such, though shown as series process blocks, individual cell 210 control (e.g., by blocks 512 through 528) and full battery pack 200 control may occur substantially simultaneously. For example, the determination of whether the maximum pack voltage has been reached at block 508 may include a substantially constant monitoring of the pack voltage, even while various cell-specific controls are occurring. Ultimately, when all the cells 210 reach their Vmax, the battery pack 200 may typically have reached its maximum operating voltage (e.g., a fully charged state), causing the decision at block 508 to result in stopping the charging cycle at block 510.

FIG. 6 shows a flow diagram of an embodiment of a method 600 for controlled discharging of a cell 210 of a battery pack 200, according to various embodiments. The method 600 begins at block 604 by measuring the voltage across the battery pack 200 to determine whether the pack voltage (e.g., the voltage across terminals 202) has reached a predetermined minimum operating pack voltage (e.g., the sum of the Vmin values for the cells of the battery pack). In some embodiments, rather than measuring the pack voltage directly at block 604, voltages of individual cells may be measured (e.g., via terminals 206).

At decision block 608, a determination is made as to whether the minimum pack voltage has been reached. For example, the minimum pack voltage may be determined as an operational minimum voltage level for the pack, as a sum of operational voltages for individual cells, as a threshold level above one or more operational voltages, etc. In some embodiments, the determination at block 608 is made by the pack controller module 230. Certain embodiments of the pack controller module 230 may be configured to perform additional detection and/or analysis functions. For example, the minimum pack voltage may not be a static value, and may instead depend on other factors, as described above.

When the determination is made at block 608 that the minimum pack voltage has been reached, the discharging cycle may be stopped at block 610. For example, a switch (e.g., a transistor, relay, etc.) may be opened to block further discharging of the battery pack 200. When the determination is made at block 608 that the minimum pack voltage has not yet been reached, the method 600 may continue, according to blocks 612 through 628, for each of the number of cells in the battery pack. For each remaining block of the method, the cell 210 currently being affected is referred to as “cell_N 210n.”

At block 612 the method 600 measures the voltage across (e.g., or current through) cell_N 210n (e.g., via terminals 206). When the cell_N 210n voltage reaches a predetermined threshold level (e.g., at or near the cell's Vmin), at block 616, a converter module turns on. In some embodiments, the secondary controller module 330 (e.g., or the primary controller module 310) in the cell controller module 220 monitors the voltage across cell_N 210n according to block 612, and begins driving the secondary driver/rectifier module 335 when the threshold level is reached according to block 616.

It is worth noting that, as with the threshold determination of block 608 (e.g., and as described with reference to blocks 508 and 516 of FIG. 5), the threshold determination involved in block 616 may include a variable threshold and/or other information, according to various embodiments. In some embodiments, as the voltage across cell_N 210n is measured in block 612, other information may be monitored as well (e.g., the rate of change in the voltage), as described above.

At block 612, the method 600 measures the voltage across the cell. When the cell voltage reaches a predetermined threshold level (e.g., at or near the cell's Vmin), at block 616, a converter module turns on. At block 628, the charging current is distributed to the cell to charge the cell. When the cell voltage returns to a level above the threshold level (e.g., or another threshold level), the converter turns off at block 632, allowing the cell to begin discharging once again.

When the converter module of cell_N 210n (e.g., the cell controller module 220) turns on, it may begin drawing current away from other cells 210 in the battery pack 200 that are not yet fully discharged at block 620. The converter module then converts the drawn current into a charging current for the fully discharged cell_N 210n at block 624. For example, as described above, a current may be transformed across a transformer 320 in the cell controller module 220, and converted (e.g., via the primary driver/rectifier module 315 controlled by the primary controller module 310) to a charging current for cell_N 210n.

At block 628, the generated charging current is distributed to cell_N 210n, causing cell_N 210n to begin charging. If the cell_N 210n voltage returns to a level above the threshold level (e.g., or to another threshold level), the converter may turn off at block 632. For example, the cell controller module 220 for cell_N 210n may stop drawing current away from the other cells 210 and may stop generating charging current for cell_N 210n. This may cause cell_N 210n to begin discharging once again.

The method 600 continues to cycle back to block 612 and back to block 604. In this way, the voltage across each cell will reach its Vmin and hover around its Vmin until all the cells reach their respective Vmin. Notably, embodiments of blocks 612 through 628 are typically performed by one or more cell controller modules 220, operating substantially asynchronously. Further, in some embodiments, the pack controller module 230 may operate substantially asynchronously with the cell controller modules 220. As such, though shown as series process blocks, individual cell 210 control (e.g., by blocks 612 through 628) and full battery pack 200 control may occur substantially simultaneously. For example, the determination of whether the minimum pack voltage has been reached at block 608 may include a substantially constant monitoring of the pack voltage, even while various cell-specific controls are occurring. Ultimately, when all the cells 210 reach their Vmin, the battery pack 200 may typically have reached its minimum operating voltage (e.g., a fully discharged state), causing the decision at block 608 to result in stopping the charging cycle at block 610.

Testing and Maintenance Embodiments

A number of potential applications are mentioned above in relation to various controller modules, for example, the cell controller module 220 described with reference to FIGS. 2-4. In some embodiments, additional information is generated and/or provided by the cell controller modules 220, either alone, together, or in conjunction with other components, such as the pack controller module 230. For example, each cell controller module 220 may be configured to output an indication (e.g., a single bit, a flag, a maintenance code, etc.) whenever the respective cell controller module 220 turns on and/or whenever the respective cell controller module 220 turns off. In other example, other information is provided, such as, other timing information (e.g., amount of time a cell controller module 220 is on, timestamps, etc.), trend information (e.g., rate of change of cell 210 voltage), etc.

According to one application, individual cells 210 may be tested, for example, to determine the cells' 210 individual Ampere-hour capacity. In some embodiments, some or all of the cells 210 in the battery pack 200 are replaceable. It may be desirable to test the cells 210 to determine which cells 210 should be replaced, rather than waiting for the entire battery pack 200 to fail. This may be particularly desirable where the battery pack 200 is not normally cycled (e.g., when used as a battery pack 200 for emergency lights, computer backup, etc.), so that the capacity of the cells may not otherwise be known.

Testing the cell 210 capacity may be performed in a number of different ways. For example, the testing could cycle through the cells 210 on a predetermined schedule. Notably, using the cell controller modules 220 may allow the battery pack 200 to remain fully functional even while one of the cells 210 is being tested. Further, when testing on the cell 210 is complete, the cell controller modules 220 would cause the cell 210 to be recharged in an optimal, balanced way, without damaging the other cells 210 in the battery pack 200. It will be appreciated that embodiments may include testing equipment, testing equipment interfaces, testing routines, maintenance and/or operating standards, etc.

In another application, reporting information from individual cell controller modules 220 (e.g., bits, flags, etc., as described above) may be used to determine whether and/or when to replace a particular cell. For example, suppose a battery pack 200 in an automotive application includes one-hundred cells. A monitoring system may be configured to monitor and flag failure (or impending failure, sub-standard performance, etc.) of individual cells 210 or groups of cells 210. When a certain number of cells 210 are flagged, a maintenance indication (e.g., a dashboard light, a maintenance code, etc.) may be communicated to indicate a need for replacement. Of course many other types of testing and maintenance applications are possible according to various embodiments.

It should be noted that the methods, systems, and devices discussed above are intended merely to be examples. For example, embodiments described with reference to small-signal and/or large-signal functionality, analog or digital signals, etc. are intended only as examples. Further, specific circuit elements are shown and/or described in some embodiments merely for clarity of description, and are not intended to be limiting.

It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

It should also be appreciated that the following systems, methods, and software may individually or collectively be components of a larger system, wherein other procedures may take precedence over or otherwise modify their application. Also, a number of steps may be required before, after, or concurrently with the following embodiments.

Specific details are given in the description to provide a thorough understanding of the embodiments. However, it will be understood by one of ordinary skill in the art that the embodiments may be practiced without these specific details. For example, well-known circuits, processes, algorithms, structures, waveforms, and techniques have been shown without unnecessary detail in order to avoid obscuring the embodiments.

Further, it may be assumed at various points throughout the description that all components are ideal (e.g., they create no delays and are lossless) to simplify the description of the key ideas of the invention. Those of skill in the art will appreciate that non-idealities may be handled through known engineering and design skills. It will be further understood by those of skill in the art that the embodiments may be practiced with substantial equivalents or other configurations. For example, circuits described with reference to N-channel transistors may also be implemented with P-channel devices, or certain elements shown as resistors may be implemented by another device that provides similar functionality (e.g., an MOS device operating in its linear region), using modifications that are well known to those of skill in the art.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Accordingly, the above description should not be taken as limiting the scope of the invention, as described in the following claims:

What is claimed is:

1. A battery pack, comprising:
a pack control module, configured to control a charging cycle at least by supplying a charging current to a plurality of cells until a pack charging threshold condition is reached, and to control a discharging cycle at least by supplying a discharging current from the plurality of cells until a pack discharging threshold condition is reached; and
a plurality of cell controller modules, each communicatively coupled at least with a respective one of the plurality of cells, and configured to:
when a cell voltage of the respective cell reaches a cell charging threshold condition during the charging cycle: shunt the charging current away from the one of the plurality of cells; use the shunted charging current to generate first supplemental current; and add at least some of the first supplemental current to the charging current to charge at least another of the plurality of cells; and
when the cell voltage of the respective cell reaches a cell discharging threshold condition during the discharging cycle: draw charging current away from the plurality of cells; use the drawn charging current to generate second supplemental current; and charge the respective cell using at least some of the second supplemental current.

2. The battery pack of claim 1, wherein the peak control module is configured to:
control the charging cycle further by measuring a pack voltage across the battery pack to determine whether the pack charging threshold condition is reached, the pack charging threshold condition being a function of a maximum operating voltage of the battery pack; and
control the discharging cycle further by measuring the pack voltage across the battery pack to determine whether the pack discharging threshold condition is reached, the pack discharging threshold condition being a function of a minimum operating voltage of the battery pack.

3. The battery pack of claim 2, wherein measuring the pack voltage comprises measuring a cell voltage for each of the plurality of cells.

4. The battery pack of claim 2, wherein the pack charging threshold condition is reached substantially when the pack voltage reaches the maximum operating voltage of the battery pack.

5. The battery pack of claim 1, wherein each cell controller module is a bi-directional direct current-to-direct current converter.

6. The battery pack of claim 1, wherein each cell controller module is configured to use the shunted charging current to substantially losslessly generate first supplemental current and to use the drawn charging current to substantially losslessly generate second supplemental current.

7. The battery pack of claim 1, wherein each cell controller module comprises:
a driver module configured, when the cell charging threshold condition is reached during the charging cycle, to shunt charging current from the respective cell and to convert the shunted charging current into a primary transmission signal;
a transmission medium configured to receive the primary transmission signal at a primary side of the transmission medium and to generate a secondary transmission signal at a secondary side of the transmission medium; and
a rectifier module, communicatively coupled with the secondary side of the transmission medium, and configured to rectify the secondary transmission signal to generate the first supplemental current.

8. The battery pack of claim 7, wherein:
the charging current and the first supplemental current are direct current signals; and
the primary transmission signal and the secondary transmission signal are alternating current signals.

9. The battery pack of claim 7, wherein each cell controller module further comprises:
a primary controller configured to detect the cell voltage of the respective cell to determine whether the cell charging threshold condition is reached during the charging cycle, and to generate at least one driver control signal,
wherein the driver module is configured to convert the shunted charging current into the primary transmission signal according to the at least one driver control signal.

10. The battery pack of claim 7, wherein each cell controller module further comprises:
a secondary controller configured to generate at least one rectifier control signal when the cell charging threshold condition is reached during the charging cycle,
wherein the rectifier module is configured to rectify the secondary transmission signal to generate the first supplemental current according to the at least one rectifier control signal.

11. The battery pack of claim 1, wherein each cell controller module comprises:
a driver module configured, when the cell discharging threshold condition is reached during the discharging cycle, to draw charging current away from the plurality of cells and to convert the drawn charging current into a secondary transmission signal;
a transmission medium configured to receive the secondary transmission signal at a secondary side of the transmission medium and to generate a primary transmission signal at a primary side of the transmission medium; and
a rectifier module, communicatively coupled with the primary side of the transmission medium, and configured to rectify the primary transmission signal to generate the second supplemental current for charging the respective cell.

12. The battery pack of claim 11, wherein each cell controller module further comprises:
a secondary controller configured to generate at least one driver control signal when the cell discharging threshold condition is reached,
wherein the driver module is configured to convert the drawn charging current into the secondary transmission signal according to the at least one driver control signal.

13. The battery pack of claim 11, wherein each cell controller module further comprises:
a primary controller configured to generate at least one rectifier control signal when the cell discharging threshold condition is reached during the discharging cycle,
wherein the rectifier module is configured to rectify the primary transmission signal to generate the second supplemental current according to the at least one rectifier control signal.

14. The battery pack of claim 1, wherein each cell controller module comprises:
a primary driver/rectifier module configured to:
shunt charging current from the respective cell and convert the shunted charging current into a primary transmission signal for communication over a transmission medium when the cell charging threshold condition is reached during the charging cycle; and
rectify the primary transmission signal received from the transmission medium to generate the second supplemental current for charging the respective cell when the cell discharging threshold condition is reached during the discharging cycle; and
a secondary driver/rectifier module configured to:
rectify a secondary transmission signal received from a transmission medium to generate the first supplemental current when the cell charging threshold condition is reached during the charging cycle; and
draw charging current away from the plurality of cells and convert the drawn charging current into the secondary transmission signal for communication over the transmission medium when the cell discharging threshold condition is reached during the discharging cycle.

15. The battery pack of claim 14, wherein:
the primary driver/rectifier module comprises four synchronous switching devices configured in a full bridge topology.

16. The battery pack of claim 14, wherein:
the secondary driver/rectifier module comprises a circuit arrangement selected from the group consisting of:
a half bridge topology comprising two synchronous switching devices;
a full bridge topology comprising four synchronous switching devices; and
a half-wave rectifier.

17. The battery pack of claim 14, wherein the transmission medium is a transformer configured to:
generate the secondary transmission signal as a function of the primary transmission signal during the charging cycle; and
generate the primary transmission signal as a function of the secondary transmission signal during the discharging cycle.

18. The battery pack of claim 17, wherein:
the transformer is configured to generate the secondary transmission signal as a function of the primary transmission signal during the charging cycle by stepping down the primary transmission signal; and
the transformer is configured to generate the primary transmission signal as a function of the secondary transmission signal during the discharging cycle by stepping up the secondary transmission signal.

19. A battery pack, comprising:
means for delivering charging current to a plurality of cells in such a way as to charge the plurality of cells;
means for controlling a charging cycle of the battery pack by, when a cell voltage of one of the plurality of cells reaches a cell charging threshold condition:
shunting the charging current away from the one of the plurality of cells;
using the shunted charging current to generate first supplemental current; and
adding at least some of the first supplemental current to the charging current to charge at least another of the plurality of cells;
means for controlling a discharging cycle of the battery pack by, when the cell voltage of the one of the plurality of cells reaches a cell discharging threshold condition:
drawing charging current away from the plurality of cells;
using the drawn charging current to generate second supplemental current; and
using at least some of the second supplemental current to charge the one of the plurality of cells;
means for terminating the charging cycle when a pack charging threshold condition is reached; and
means for terminating the discharging cycle when a pack discharging threshold condition is reached.

20. A method for controlling a battery pack, the method comprising:
monitoring a pack voltage during a charging cycle of the battery pack to determine whether a pack charging threshold condition is reached;
monitoring a cell voltage for one of a plurality of cells of the battery pack to determine whether a cell charging threshold condition is reached;
when the pack charging threshold condition is not reached and the cell charging threshold condition is not reached for the one of the plurality of cells, supplying a charging current to the one of the plurality of cells;
when the pack charging threshold condition is not reached and the cell charging threshold condition is reached for the one of the plurality of cells: shunting the charging current away from the one of the plurality of cells; using the shunted charging current to generate first supplemental current; and adding at least some of the first supplemental current to the charging current to charge at least another of the plurality of cells; and
when the pack charging threshold condition is reached, terminating the charging cycle.

21. The method of claim 20, wherein using the shunted charging current to generate the first supplemental current comprises:
converting the shunted charging current into a primary transmission signal;
transforming the primary transmission signal across a transmission medium to generate a secondary transmission signal; and
rectifying the secondary transmission signal to generate the first supplemental current.

22. The method of claim 20, further comprising:
monitoring a pack voltage during a discharging cycle of the battery pack to determine whether a pack discharging threshold condition is reached;
monitoring a cell voltage for one of a plurality of cells of the battery pack to determine whether a cell discharging threshold condition is reached;
when the pack discharging threshold condition is not reached and the cell discharging threshold condition is not reached for the one of the plurality of cells, drawing output current from the one of the plurality of cells for use as output current of the battery pack;
when the pack discharging threshold condition is not reached and the cell discharging threshold condition is reached for the one of the plurality of cells: drawing charging current away from the plurality of cells; using the drawn charging current to generate second supplemental current; and charging the one of the plurality of cells using at least some of the second supplemental current; and
when the pack discharging threshold condition is reached, terminating the discharging cycle.

23. The method of claim 22, wherein using the drawn charging current to generate the second supplemental current comprises:
converting the drawn charging current into a secondary transmission signal;
transforming the secondary transmission signal across a transmission medium to generate a primary transmission signal; and
rectifying the primary transmission signal to generate the second supplemental current for charging the one of the plurality of cells.
